(19) United States
(12) Patent Application Publication
(10) Pub. No.: US 2011/0193436 A1
(43) Pub. Date: Aug. 11, 2011

(54) ELECTRIC MOTOR

(75) Inventor: Frank Richter, Buehl (DE)

(73) Assignee: ROBERT BOSCH GMBH, Stuttgart (DE)

(21) Appl. No.: 13/023,557

(22) Filed: Feb. 9, 2011

(30) Foreign Application Priority Data
Feb. 9, 2010 (DE) 10 2010 001 689.6

(51) Int. Cl. H02K 5/10

(52) U.S. Cl. 310/88

(57) ABSTRACT

The invention provides an electric motor (10), with a housing (12) and a cover (14) which closes the housing (12) at one axial end and carries a bearing (15) for a drive shaft (13) led through. The electric motor (10) is characterized by a partitioning (20), provided on the side of the bearing (15) facing the interior of the housing (16), of a functional part in the housing (12) to prevent media, for example liquid, from getting into the interior of the housing (16) from outside at the bearing (15).

### BACKGROUND OF THE INVENTION

The invention is based on an electric motor, with a housing and a cover which closes the housing at one axial end and carries a bearing for a drive shaft led through.

Electric motors are often flange-mounted with the axial end face that has the cover and the bearing directly onto assemblies to be driven, for example onto hydraulic units to be driven, for example radial piston pumps. Owing to leakages of such hydraulic units, the bearing in the cover is exposed to medium, for example liquid, from outside. Conventional bearings, for example rolling bearings, do not guarantee seal-tightness against liquid media, so that such media can get through the bearing on the cover into the interior of the housing. Functional parts following on axially from the bearing, in the case of an electric motor for example a commutating device, are contained in the interior of the housing. For these there is the risk of being contaminated by media, for example liquids, that get through the bearing on the cover into the interior of the housing. In such a case, the power values of the electric motor deteriorate, possibly to the point of complete failure, on account for example of ‘pasting’ of the commutator or the entire commutating device.

### SUMMARY OF THE INVENTION

The electric motor according to the invention has the advantage that, as a result of the axial partitioning between the bearing and an axially following functional part in the motor housing, this functional part, which may for example be a commutating device, is protected by the partitioning from media getting through, for example liquid. Any penetrating medium, in particular liquid, is intercepted by the partitioning, kept away from the following functional part, for example a commutating device, and directed away from critical regions in the housing to uncritical regions in the housing, for example to leakage pockets or the like provided there. The partitioning, in particular in the form of a bulkhead, creates the preconditions for allowing particular gap conditions to be specifically set between the bulkhead and the bearing and the cover by specifically designing components concerned, particularly the bulkhead. The resultant capillary actions can be used to direct the penetrating medium, for example liquid, specifically away from a critical region to an uncritical region. The bulkhead can be easily fastened to the cover in a reproducible and permanent manner, the bulkhead butting against the cover. In this way it is possible to ensure the gap dimensions that are intended according to the design, on the one hand with respect to the cover and on the other hand with respect to the bearing, and keep the penetrating medium, for example liquid, away from the functional part, for example a commutating device of the electric motor, by using the capillary forces. During the design, the gap conditions are chosen and set according to the medium, for example liquid, and the properties thereof, such as viscosity, creep behavior or the like.

It may be advantageous if the partitioning, particularly the bulkhead, has a number of arms, which are spaced apart in the circumferential direction and preferably butt against retaining areas of the cover with form-fitting engagement. Depending on the configuration, this abutment may take place with a clamping action, so that no fastening elements are required for fastening the partitioning to the cover. The cover may preferably have as a retaining area a peripheral bead ring, against which the bulkhead butts, at least with its arms. The abutment may take place with contact over the surface area and consequently with form-fitting engagement. It may be advantageous, furthermore, if the bulkhead is fastened to the cover by means of separate retaining elements, for example retaining brackets, retaining clamps or the like, which reach over the arms, the retaining elements for their part being fastened to the cover by means of fastening elements on the cover side, for example pins, projections, rivets or the like. Instead of this, the retaining elements may also have fastening means of their own, which act on the cover. The arrangement is advantageously set up in such a way that the bulkhead is fastened to the cover directly by at least two arms lying opposite each other, for example diametrically, or else by means of respective retaining elements. The cover may have on the axial side facing the interior of the housing fastening elements, for example pins, projections, rivets or the like, with which the bulkhead is fastened to the cover in the region of its arms directly or by means of the separate retaining elements. It may be of particular advantage if the partitioning, particularly the bulkhead, and the cover are formed by a one-piece component made of one material.

### DESCRIPTION OF THE DRAWINGS

The invention is explained in more detail in the following description on the basis of an exemplary embodiment that is represented in the drawings, in which, in a respectively schematic representation:

FIG. 1 shows a schematic, partly sectional side view of an electric motor,

FIG. 2 shows a perspective view of a bulkhead of the electric motor in FIG. 1,

FIG. 3 shows a schematic section of the bulkhead in FIG. 2,

FIG. 4 shows a side view of the bulkhead in FIG. 2,

FIG. 5 shows a schematic section of a detail according to a second embodiment,

FIG. 6 shows a schematic perspective view of the rear side of the cover with partitioning attached thereto according to FIG. 5,

FIG. 7 shows a schematic section of a detail according to a third exemplary embodiment,

FIG. 8 shows a schematic perspective view of the rear side of the cover with partitioning retained thereon according to FIG. 7,

FIG. 9 shows a schematic perspective view of a bulkhead according to a fourth exemplary embodiment.

### DETAILED DESCRIPTION

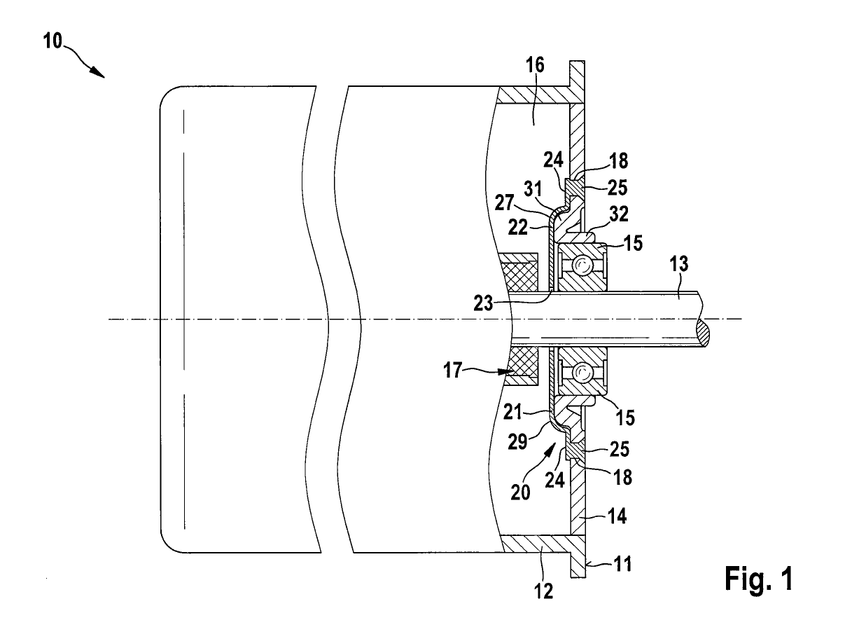

In FIG. 1, an electric motor 10 for driving an assembly that is not shown any further is schematically represented, this assembly possibly consisting for example of a hydraulic unit. The electric motor 10 and this assembly are fitted together, the electric motor 10 being flange-mounted with its end face 11 onto the assembly. The electric motor 10 has a drive shaft 13, which is led out from the housing 12 of said motor and can be driven rotationally in one direction when the electric motor 10 is switched on. The drive shaft 13 may extend into the flange-mounted assembly that is not shown.

The housing 12 of the electric motor 10 is shaped approximately in the form of a pot and is closed at one axial end by means of a cover 14, which carries a bearing 15 for the drive shaft 13 led through. The drive shaft 13 extends into the interior of the housing 16 and carries there, in the conventional way, the armature of the electric motor 10, with a drive shaft 13 being mounted in the bottom region of the approximately pot-shaped housing 12. At an axial distance from the bearing 15, the drive shaft 13 carries in the interior of the housing 16 a conventional commutating device 17, which in FIG. 1 is only schematically indicated. The bearing 15 in the cover 14 consists of a rolling bearing, for example a ball bearing. Such bearings 15 do not ensure absolute seal-tightness against penetration of media, for example liquids, from outside into the bearing 15, and through the latter into the interior of the housing 16. In particular whenever the electric motor 10 is connected in the way described to a hydraulic unit as the assembly, hydraulic fluid can get through the bearing 15 into the interior of the housing 16. This normally has the consequence that the commutating device 17 located behind said bearing is contaminated with liquid, which can inevitably lead to great deterioration of the power values, possibly to the point of failure, of the electric motor 10, since for example the commutator or the entire commutating device 17 is ‘pasted’.

The problems described here are eliminated in the case of the electric motor 10 according to the invention. The commutating device 17 arranged axially behind the bearing 15 is protected from media, for example liquids, that get through the bearing 15 into the interior of the housing 16. For this purpose, a partitioning, denoted generally by 20, is provided on the side of the bearing 15 facing the interior of the housing 16, for the commutating device 17 as a functional part of the electric motor 10 in the housing 12 to prevent media, for example liquids, from getting into the interior of the housing 16 from outside at the bearing 15. This partitioning 20 has a bulkhead 21, which is passed through by the drive shaft 13 and extends in the radial direction at least over the radial region of the bearing 15. The partitioning 20 in the form of the bulkhead 21 is arranged axially between the bearing 15 and the commutating device 17 as protection for the latter. The partitioning 20 acts as a surface-area covering of the bearing 15. It prevents medium, particularly liquid, from getting through the bearing 15 from outside into the interior of the housing 16 and directly into the region of the commutating device 17. The medium, particularly the liquid, and here for example the oil, is intercepted by the bulkhead 21. The gap dimensions between the bearing 15 and the partitioning 20, particularly the bulkhead 21, may in this case be chosen such that medium intercepted by means of the partitioning 20 is kept away from the commutating device 17 as a result of capillary action. In an advantageous way, the medium intercepted, for example in the housing 12, can be directed to uncritical points, for example to leakage pockets or the like provided there. By using capillary actions that occur, the medium, for example liquid, can consequently be directed away from critical regions specifically to uncritical regions.

The partitioning 20 is fixed in a constant position with respect to the cover 14 and butts against the cover 14 with surface-area contact. It is fastened to the cover 14 with force- and/or form-fitting engagement. Various fastening methods, for example by screwing, adhesive bonding, welding, soldering or brazing, clipping, riveting or other such methods, are suitable for the fastening. When doing this, the position of the bulkhead 21 with respect to the cover 14 should be constant, which is achieved by the bulkhead 21 butting against the cover 14. This ensures retention of the gap dimensions with respect to the cover 14 and with respect to the bearing 15, through which medium, particularly liquid, penetrating on account of the capillary forces is kept away from the commutating device 17.

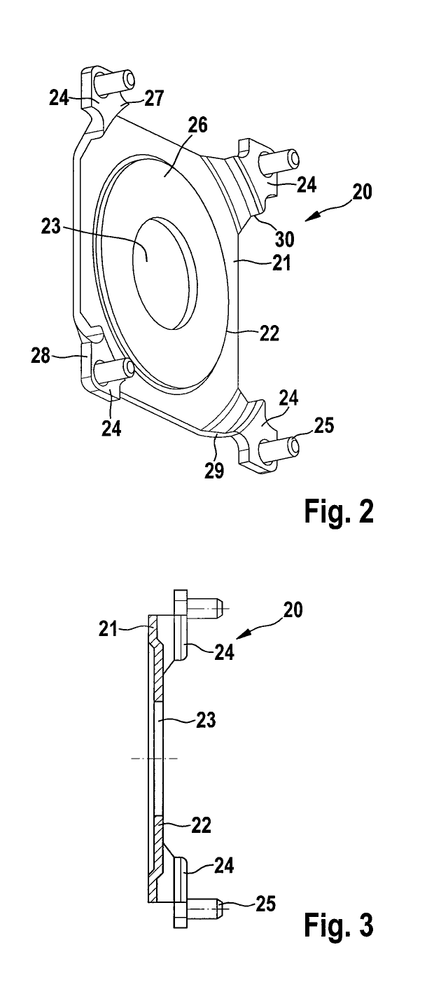

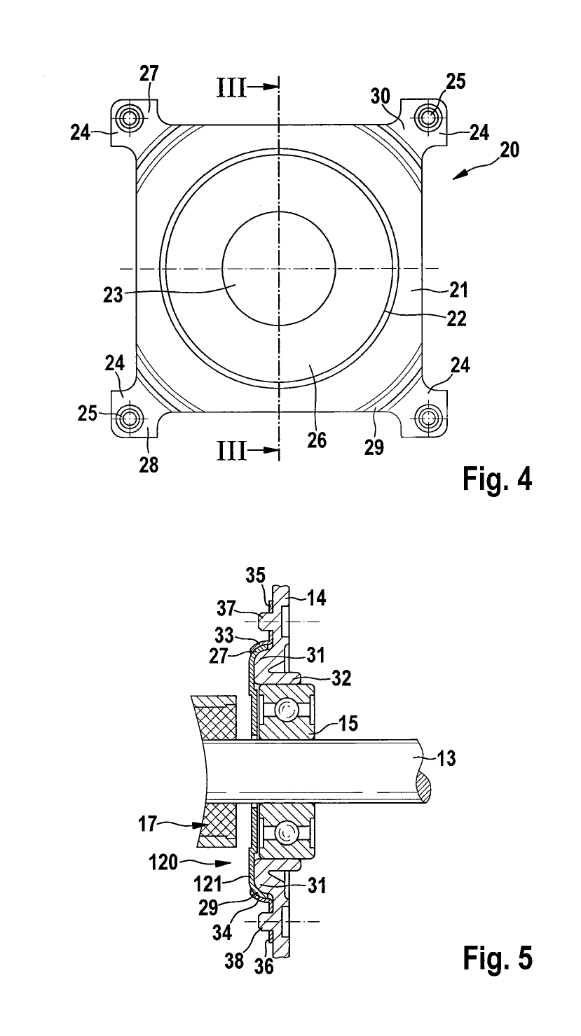

The partitioning 20, particularly the bulkhead 21, may be formed from plastic or from metal, preferably as an injection-molded plastic part, a stamped metal part or the like. As evident in particular from FIGS. 2 to 4, the partitioning 20 has an approximately disk-shaped plate 22 with a central passage 23 for the drive shaft 13 and outer fastening elements 24 located at a radial distance therefrom. The type of fastening elements 24 depends on the fastening method. The fastening elements 24 may, for example, have pin-like projections 25, which pass through passage openings 18 in the cover 17 for the fastening of the plate 22. The projections 25 may be deformable in such a way that they make it possible for the bulkhead 21 to be fastened to the cover 14 by riveting. In the case of the exemplary embodiment shown, the bulkhead 21 is shaped as an approximately four-cornered plate 22, which has an annular inner part 26, which radially extends at least over the range of the diameter of the bearing 15.

It is evident from the drawings that the partitioning 20, particularly the bulkhead 21, has a number of arms 27 to 30, which are spaced apart in the circumferential direction and preferably butt against retaining areas of the cover 14 with form-fitting engagement. In a simple way, the cover 14 has as the retaining area a peripheral bead ring 31, which projects toward the interior of the housing 16 and follows on in one piece from the annular collar 32, which serves for receiving the bearing 15.

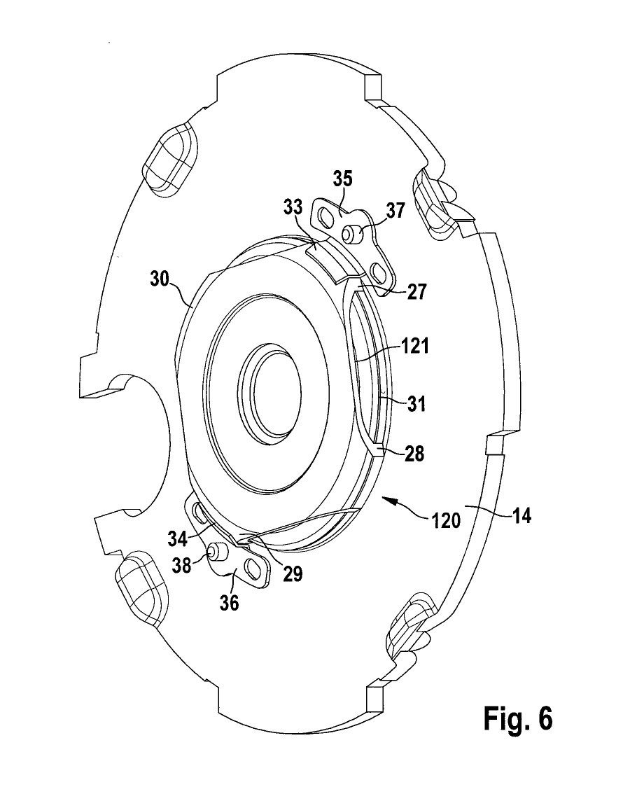

In the case of the second exemplary embodiment, shown in FIGS. 5 and 6, the partitioning 120, particularly bulkhead 121, has no fastening means of its own. In this case, however, as in FIGS. 1 to 4, the bulkhead 121 is provided with a number of arms 27 to 30, which are spaced apart in the circumferential direction and preferably butt with form-fitting engagement against corresponding points of the bead ring 31 of the cover 14 as the retaining area, as can be seen in particular from FIG. 5. Here, too, four such arms 27 to 30 are provided. Separate retaining elements 33, 34 serve for fastening the bulkhead 121 to the cover 14 and are, for their part, fastened to the cover 14. The retaining elements 33, 34 are designed as holding brackets, holding clamps or the like and in such a way that they reach over the arms 27 and 29 concerned, for instance with form-fitting engagement. With a fastening part 35, 36, the retaining elements 33, 34 are fastened to the cover 14 by means of fastening elements 37, 38 on the cover side. The fastening elements 37, 38 consist, for example, of pins, projections, rivets or such elements, which make it possible for the retaining elements 33, 34 to be fixed to the inner side of the cover 14. In the case of the second exemplary embodiment according to FIGS. 5 and 6, the bulkhead 121 has four arms 27 to 30, with two arms 28 and 30 lying diametrically opposite each other and butting against the bead ring 31, for instance with form-fitting engagement, while the other two arms 27, 29, lying diametrically opposite each other, are additionally fixed by means of the retaining elements 33, 34.

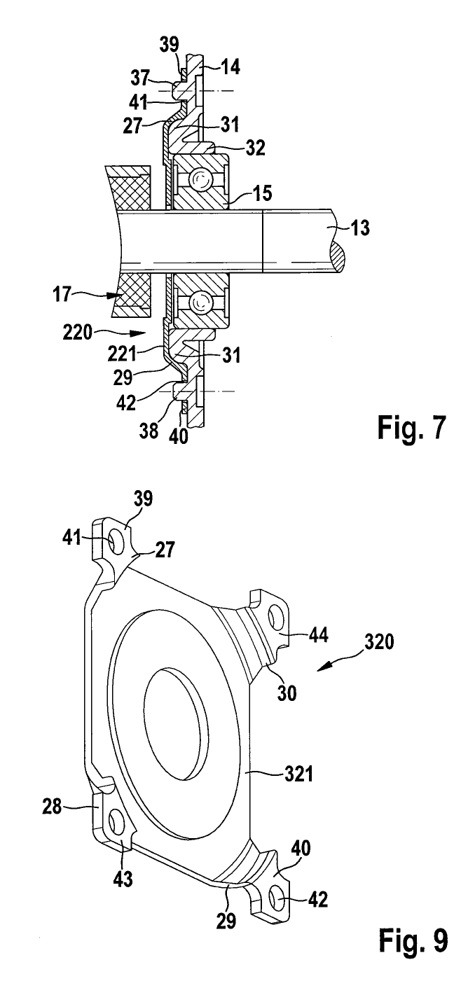

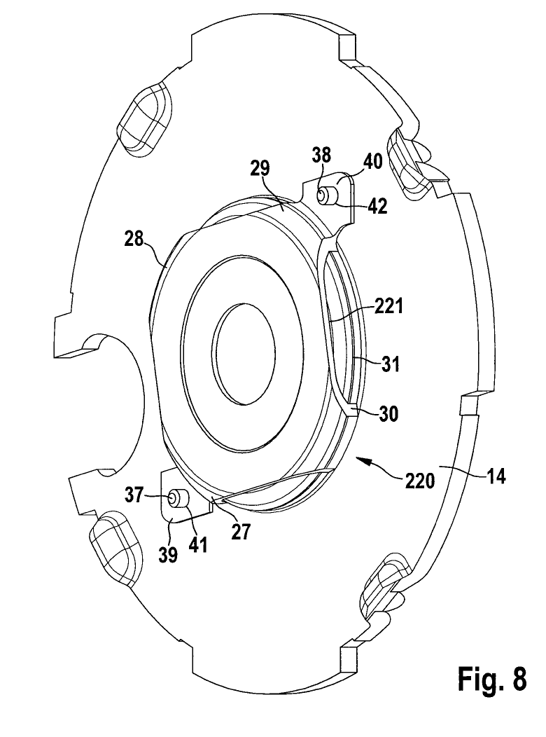

In the case of the third exemplary embodiment, shown in FIGS. 7 and 8, the bulkhead 221 is fastened on the rear side of the cover 14, likewise by means of fastening elements 37, 39 on the cover side, but directly without retaining elements 33, 34 according to FIGS. 5 and 6. Two arms 28, 30, lying diametrically opposite each other, butt in turn against the bead ring 31, approximately with form-fitting engagement, while two other arms 27 and 29 are radially extended to form fastening parts 39, 40. The fastening parts 39, 40 contain passage openings 41, 42, through which the fastening elements 37, 38 on the cover side can reach for fastening. The fastening parts 39, 40 of the bulkhead 221 butt flat against the rear side of the cover 14.

The fourth exemplary embodiment, shown in FIG. 9, differs from the third exemplary embodiment in that here the bulkhead 321 has on all four arms 27 to 30 protruding fastening parts 39, 40 as well as 43 and 44, which serve for fastening the bulkhead 321 to the cover 14 by means of fastening elements on the cover side. Here it may be sufficient for fastening to take place at just two points lying diametrically opposite each other.

In the case of another exemplary embodiment that is not shown, the partitioning 20, particularly the bulkhead, and the cover 14 are formed by a one-piece component made of one material. Here, the region of the partitioning 20, in particular the bulkhead, is formed on the cover 14 in one piece and, for partitioning, extends radially over the inner side of the bearing 15.

1. An electric motor, with a housing (12) and a cover (14) which closes the housing (12) at one axial end and carries a bearing (15) for a drive shaft (13), the housing having an interior, characterized by a partitioning (20; 120; 220; 320), provided on a side of the bearing (15) facing the interior of the housing (16), of a functional part in the housing (12) to prevent media from getting into the interior of the housing (16) from outside at the bearing (15).

2. The electric motor according to claim 1, characterized in that the partitioning (20; 120; 220; 320) has a bulkhead (21; 121; 221; 321).

3. The electric motor according to claim 1, characterized in that the partitioning (20; 120; 220; 320) is passed through by the drive shaft (13).

4. The electric motor according to claim 1, characterized in that the partitioning (20; 120; 220; 320) extends in a radial direction at least over a radial region of the bearing (15).

5. The electric motor according to claim 1, characterized in that the partitioning (20; 120; 220; 320) is fixed with respect to the cover (14) in a constant position.

6. The electric motor according to claim 1, characterized in that the partitioning (20; 120; 220; 320) is fastened to the cover (14) with force- and/or form-fitting engagement.

7. The electric motor according to claim 1, characterized in that the partitioning (20; 120; 220; 320) is formed from plastic or metal.

8. The electric motor according to claim 1, with a commutating device (17) provided at an axial distance from the bearing (15), characterized in that the partitioning (20; 120; 220; 320) is arranged axially between the bearing (15) and the commutating device (17) as protection for the commutating device.

9. The electric motor according to claim 8, characterized in that gap dimensions between the bearing (15) and the partitioning (20; 120; 220; 320) are chosen such that medium intercepted by means of the partitioning (20; 120; 220; 320) is kept away from the commutating device (17) as a result of capillary action.

10. The electric motor according to claim 1, characterized in that the partitioning (20; 120; 220; 320) has an approximately disk-shaped plate (22) with a central passage (23) for the drive shaft (13) and outer fastening elements (24) located at a radial distance therefrom.

11. The electric motor according to claim 1, characterized in that the partitioning (20; 120; 220; 320) is fixed with respect to the cover (14) in a constant position and in that the partitioning (20; 120; 220; 320) butts against the cover (14).

12. The electric motor according to claim 1, characterized in that the partitioning (20; 120; 220; 320) is formed from plastic or metal and is formed as a molded part or stamped part.

13. The electric motor according to claim 9, characterized in that medium intercepted by means of the partitioning (20; 120; 220; 320) is directed to uncritical points in the housing (12).

14. The electric motor according to claim 13, characterized in that medium intercepted by means of the partitioning (20; 120; 220; 320) is directed to leakage pockets in the housing (12).

15. The electric motor according to claim 8, characterized in that the partitioning (20; 120; 220; 320) has a bulkhead (21; 121; 221; 321), and characterized in that the gap dimensions between the bearing (15) and the bulkhead (21; 121; 221; 321) are chosen such that medium intercepted by means of the partitioning (20; 120; 220; 320) is kept away from the commutating device (17) as a result of capillary action.

16. The electric motor according to claim 15, characterized in that medium intercepted by means of the partitioning (20; 120; 220; 320) is directed to uncritical points in the housing (12).

17. The electric motor according to claim 16, characterized in that medium intercepted by means of the partitioning (20; 120; 220; 320) is directed to leakage pockets in the housing (12).

18. The electric motor according to claim 1, characterized in that the partitioning (20; 120; 220; 320) has an approximately disk-shaped plate (22) with a central passage (23) for the drive shaft (13) and outer fastening elements (24) in the form of projections (25) located at a radial distance therefrom.
